(19) United States
(12) Patent Application Publication
(10) Pub. No.: US 2015/0374176 A1
(43) Pub. Date: Dec. 31, 2015

(54) CARVING PIN FOR CARVING A COOKED ROAST, AND METHODS AND SYSTEMS

(71) Applicant: James Hamilton, Lambertsville, NJ (US)

(72) Inventor: James Hamilton, Lambertsville, NJ (US)

(21) Appl. No.: 14/753,267

(22) Filed: Jun. 29, 2015

Related U.S. Application Data
(60) Provisional application No. 62/018,831, filed on Jun. 30, 2014.
(60) Provisional application No. 62/018,750, filed on Jun. 30, 2014.

(51) Int. Cl. A47J 47/00; A23L 1/31; A47J 47/16

(52) U.S. Cl. CPC A47J 47/005; A47J 47/16; A23L 1/31; A23V 2002/00

(57) ABSTRACT

A carving pin, a method for using the carving pin to carve a cooked roast, and a system for carving a cooked roast comprising the carving pin are provided. The carving pin comprises a base and a spike member connected to the base at about a 90° angle at about the center of the base, protruding upwards from the base. The spike member comprises a spike member end and a spike member body, the spike member end being sharp (i.e., tapered such that the very top is the sharpest) and being located distal to the base, the spike member end being connected continuously to the spike member body (i.e., all in one piece). The spike member end is adapted to pierce the cooked roast such that the cooked roast traverses the spike member and rests on the base.

### TECHNICAL FIELD OF THE INVENTION

This invention relates to kitchen utensils.

### BACKGROUND

Carving a cooked roast generally involves resting a cooked roast on a carving board and then keeping the cooked roast in place with one utensil in one hand while carving the cooked roast with a knife held in the other hand; both hands are needed to carve the cooked roast. Often the cooked roast moves too much and can thus be difficult to handle.

### SUMMARY OF THE INVENTION

This invention solves the problem above by providing a carving pin that holds and secures the cooked roast thus allowing one to have both hands free, to, for example, carve the cooked roast. This invention provides a method for carving a cooked roast using the carving pin and a system for carving a cooked roast comprising the carving pin.

The carving pin can be in one piece. The carving pin comprises a base and a spike member connected to the base at about a 90° angle at about the center of the base, protruding from the base. The spike member comprises a spike member end and a spike member body, the spike member end being sharp (tapered) and located distally from the base. The spike member end and the spike member body can be in one piece and the spike member and the base can be in one piece. The spike member end is adapted to pierce the cooked roast, such that the cooked roast traverses the spike member and rests on the base securely.

Numerous other aspects are provided in accordance with these and other aspects of the invention. Other features and aspects of the present invention will become more fully apparent from the following detailed description, the appended claims and the accompanying drawings.

### BRIEF DESCRIPTION OF THE DRAWINGS

Features of the present invention can be more clearly understood from the following detailed description considered in conjunction with the following drawings, in which the same reference numerals denote the same elements throughout, and in which:

FIG. 1 is a schematic view of a carving pin according to embodiments of the present invention.

FIG. 2 is a schematic view of another carving pin according to embodiments of the present invention.

FIG. 3 is a flowchart illustrating a method according to embodiments of the present invention.

FIG. 4 is schematic view of a system according to embodiments of the present invention.

### DETAILED DESCRIPION OF THE INVENTION

This invention provides a carving pin for carving a cooked roast such that both hands remain free and can both be used to carve the cooked roast. This invention also provides a method for carving a cooked roast using the carving pin. In another aspect, this invention provides a system for carving a cooked roast comprising the carving pin.

This invention provides a carving pin. The carving pin comprises a base and a spike member connected to the base at about a 90° angle, at about the center of the base, protruding upwards from the base. The carving pin can be in one piece.

The carving pin can be made of any suitable material. In some embodiments, the carving pin is made of stainless steel. The carving pin can be made by methods known in the art, including, for example, by sculpting, welding, chiseling, 3-D printing, etc. The carving pin can be of any color. The carving pin, and any part(s) thereof, can be filled (i.e., not hollow), hollow, or partially hollow.

In certain embodiments, the spike member and the base are continuous, i.e., all in one piece, which can be accomplished by, for example, welding the spike member to the base, and by any other conventional methods (including being made as a single piece). The spike member can also be placed into the base by, for example, fastening, using a fastener such as a screw, taping, gluing, and other conventional methods for connecting two such objects.

The spike member comprises a spike member end and a spike member body. The spike member end is sharp (i.e., tapered such that the tip, which is the most distal point of the spike member end from the base, is the sharpest), such that it is adapted to pierce a cooked roast, and is located distal to the base. In certain embodiments, the spike member end is connected continuously to the spike member body (i.e., all in one piece). The spike member end and the spike member body can be made as a single piece. The spike member end is at the end of the spike member and is located distally from the base and differs from the spike member body in that it has been sharpened (so as to be tapered at the end distal from the base) and is thus adapted to pierce the cooked roast. The spike member end can be sharpened by conventional sharpening tools and methods or be constructed to be tapered by any conventional methods. The sharpness of the spike member end is such that a cooked roast can be pierced by the spike member end and the cooked roast can then traverse the spike member. The spike member end pierces the cooked roast, the cooked roast then traverses the spike member and ends up resting securely on the base. Together, the cooked roast on the carving pin can then be placed onto a carving board for carving.

The carving pin is for holding and securing a cooked roast so that it can be more easily carved, as both hands would be free and not needed to hold the cooked roast. The carving pin is not intended to be used for cooking or roasting; it is intended to be used after the roast is cooked. It is not a cooking utensil; but rather one for use after the cooking is completed. The carving pin is adapted for holding and securing a cooked roast and not adapted for use in cooking (including roasting) a roast.

The cooked roast can be any cooked roast, usually cooked in an oven (always cooked without the carving pin), and includes, for example, a turkey, chicken, beef, pork, lamb, veal, and ham roast.

In certain embodiments, the carving pin is between about 7, about 7 1/2, about 7¾, to about 8 inches tall (i.e., long). The carving pin can be more or less than about 8 inches tall (i.e., long). In certain embodiments, the spike member is between about 7 to about 8 inches tall (i.e., long). In certain embodiments, the spike member is about 7½ inches tall (i.e., long). In certain embodiments, the spike member is a height that allows a cooked roast to traverse completely through the spike member such that part of the spike member end protrudes out of the cooked roast. In other embodiments, the spike member is a height that does not necessarily allow all cooked roasts or any cooked roast to traverse completely through the spike member. In some embodiments, the spike member end is about ¾ inch long. In some embodiments, the spike member body is cylindrical. In some embodiments, the cylindrical spike member body is about 5/16 inch in diameter.

The base of the carving pin can be of any length, size, and thickness. The base is of a size, length, and thickness sufficient to have a cooked roast resting on it securely. In certain embodiments, the base of the carving pin is about 6 inches, about 5 inches, or about 4 inches long. In certain embodiments, the base is about ¼ inch thick.

In certain embodiments, the base is a plate. In some embodiments, the base is a stainless steel plate. In certain embodiments, the base is a square plate or a rectangular plate. In certain embodiments, the base is a square plate that is about 4 inches in length on each side. In certain embodiments, the base is a plate that further comprises a small hole, adapted to allow the carving pin to be hung on, for example, a hook, and can be used for storage; and in certain further embodiments, the hole is circular. In some further embodiments, the circular hole has a diameter of about ⅜ inch. The base is adapted to allow the cooked roast to rest on it securely after the cooked roast has pierced the spike member end and traversed the spike member.

The base is not a carving board and is not to be used as a carving board. The base is not adapted to be used as a carving board. In certain embodiments, the base and the spike member are all in one piece.

In some embodiments, the base is a loop with two ends with one end of the loop abutting the spike member body, and the spike member body is at about 90° to the base (i.e., about perpendicular to the base), at around the center of the base. In certain embodiments, the loop can be used to hang the carving pin on, for example, a hook. In some embodiments, the base comprises a hole, which can be circular and can be about 5/16 inch in diameter (other dimensions are contemplated) and is adapted to receive the spike member.

This invention also provides a method for carving a cooked roast, comprising:
(a) providing a carving pin of this invention,
(b) providing a cooked roast,
(c) piercing the cooked roast with the spike member end of the carving pin such that the cooked roast traverses the spike member and the cooked roast is resting securely on the base,
(d) placing the cooked roast on the carving pin onto a carving board, which can be any carving board (also known as a cutting board) and can be made of any material, such as, for example, wood or plastic, and
(e) carving the cooked roast with one or more carving instruments, which can be any carving instrument, such as, for example, forks, prongs and knives, wherein both hands are free to hold the carving instruments.
   The cooked roast can traverse the spike member completely with the spike member end protruding out of the cooked roast. This invention further provides a system for carving a cooked roast, comprising a carving pin of this invention, a cooked roast, a carving board, which can be any carving board (also known as a cutting board) and can be made of any material, such as, for example, wood or plastic, and one or more carving instruments, such as, for example, forks, prongs and knives, which can be held by one or both hands. The cooked roast on the carving pin can be placed on the carving board. The spike member end can pierce the cooked roast and the cooked roast can then traverse the spike member and rest securely on the base of the carving pin. The cooked roast can traverse the spike member completely with the spike member end protruding out of the cooked roast.

This invention also provides a kit for carving a cooked roast comprising a carving pin of this invention and instruction(s) for use, such as, for example, instruction(s) that comprise a method of this invention, or, for example, that includes descriptions of a system of this invention. In some embodiments, the kit further comprises a carving board, which can be any carving board (also known as a cutting board) and can be made of any material, such as, for example, wood or plastic. In some embodiments, the kit further comprises one or more carving instruments, such as, for example, forks, prongs and knives.

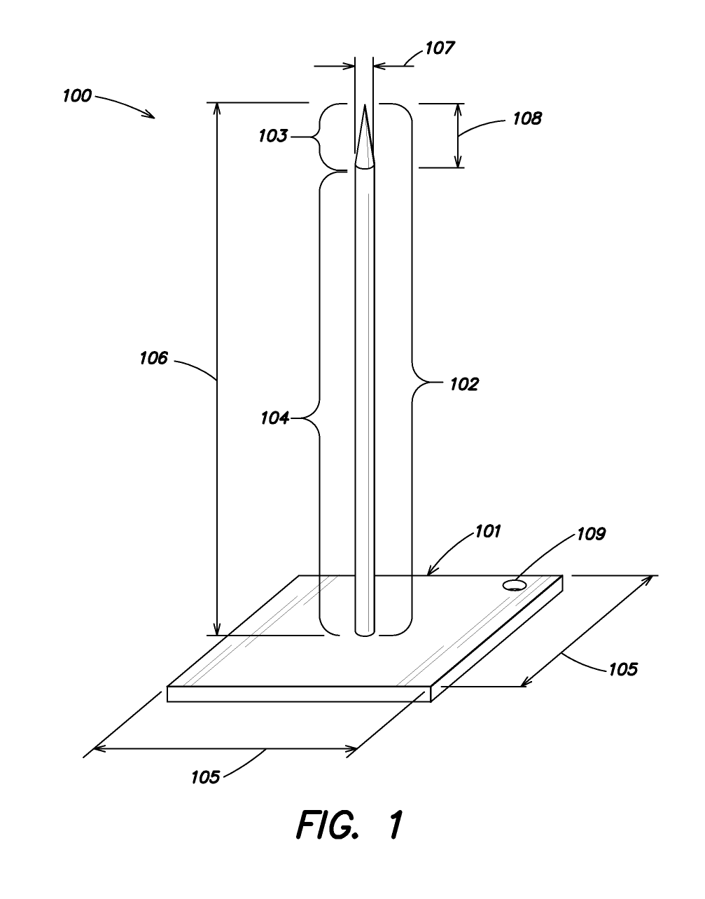

These and other embodiments of the systems, apparatus, and methods are described below with reference to FIGS. 1-4 wherein like numerals are used throughout to denote like elements.

FIG. 1 shows an exemplary embodiment of a carving pin 100 of the invention. The carving pin 100 is all in one piece and is made of stainless steel. The carving pin 100 comprises a base 101 and a spike member 102 at about the center of the base. The spike member 102 protrudes upwards from the base 101. The spike member 102 protrudes at about a 90° angle from the base 101 and is located at about the center of the base 101. The spike member 102 comprises a spike member end 103 and a spike member body 104, the spike member end 103 and the spike member body 104 being continuous with each other (i.e., all in one piece). The spike member body 104 is cylindrical and the spike member end, being distal to the base 101, is sharp at the end (i.e., tapered). The base 101 and the spike member 102 are continuous (i.e., all in one piece). The base 101 is a square plate that is about 4 inches in length on all four sides 105 and the spike member 102 is about 7½ inches tall (i.e., long) 106. The spike member body 104 is about 5/16 inch in diameter 107. The spike member end 103 is about ¾ inch in length 108. The base 101 can be about ¼ inch thick. The base can further comprise a hole 109 to allow the carving pin to be hung, for example, on a hook, allowing for storage. The hole can be circular with a diameter of about ⅜ of an inch; and the center of the circle of the hole 109 can be about ⅜ inch from the edge of the base 101. The spike member 102 can be welded onto the base 101 so that the carving pin is all one piece.

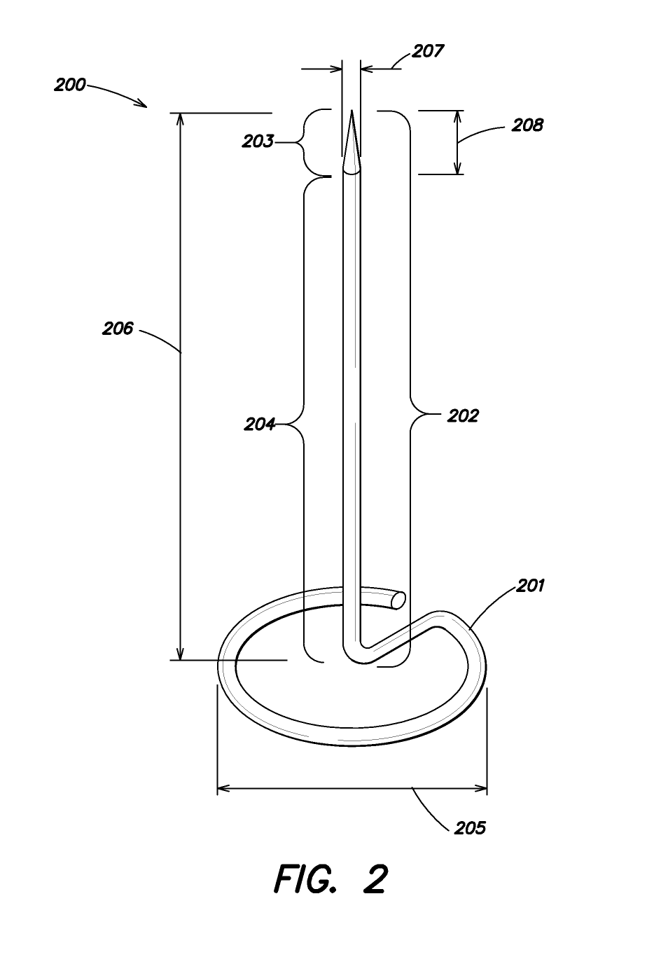

FIG. 2 shows another exemplary embodiment of a carving pin 200 of the invention. The carving pin 200 is all in one piece and is made of stainless steel; and the carving pin 200 can be between about 7¾ inches to about 8 inches tall (i.e., long). The carving pin 200 comprises a base 201 and a spike member 202 that protrudes upwards from the base 201. The spike member 202 protrudes at about a 90° angle from the base 201 and is located at about the center of the base 201. The spike member 202 comprises a spike member end 203 and a spike member body 204, the spike member end 203 and the spike member body 204 being continuous with each other (i.e., all in one piece). The base 201 and the spike member 202 are continuous (i.e., all in one piece). The base 201 is in the shape of a loop with two ends, with one end of the loop abutting the spike member body 204, and the spike member body 204 is at about 90° to the base 201. The base 201 is about 4 inches long 205. The spike member is about 7½ inches tall 206 (i.e., long). The spike member body 204 is cylindrical and is about 5/16 inch in diameter 207. The base 201 abuts the spike member 202. The spike member end 203 is about ¾ inch long 208. The base 201 is a loop. The first part of the loop that is in contact with the spike member body 204 and runs almost straight before the loop bends sharply can be about 2 inches long. The loop can be about 5/16 inch in diameter and is made of stainless steel. The spike member can be welded onto the base so that the carving pin is in one piece. The spike member and the base can be made as a single piece. The spike member can be fastened onto the base by conventional fasteners.

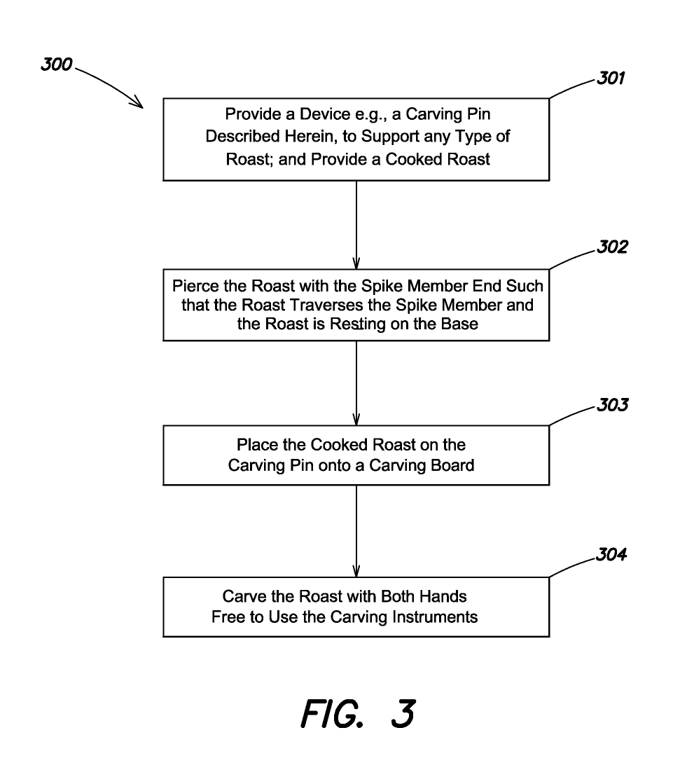

FIG. 3 illustrates a method for carving a cooked roast using the carving pin of this invention. The method 300 comprises in 301 providing a carving pin of this invention and a cooked roast. The carving pin is a carving pin of this invention as described above. The method 300 comprises in 302 piercing the cooked roast with the spike member end such that the cooked roast traverses the spike member and the cooked roast is resting securely on the base. The method 300 comprises in 303 placing the cooked roast on the carving pin onto a carving board. And the method 300 comprises in 304 carving the cooked roast with one or more carving instruments, wherein both hands are free to hold the carving instruments.

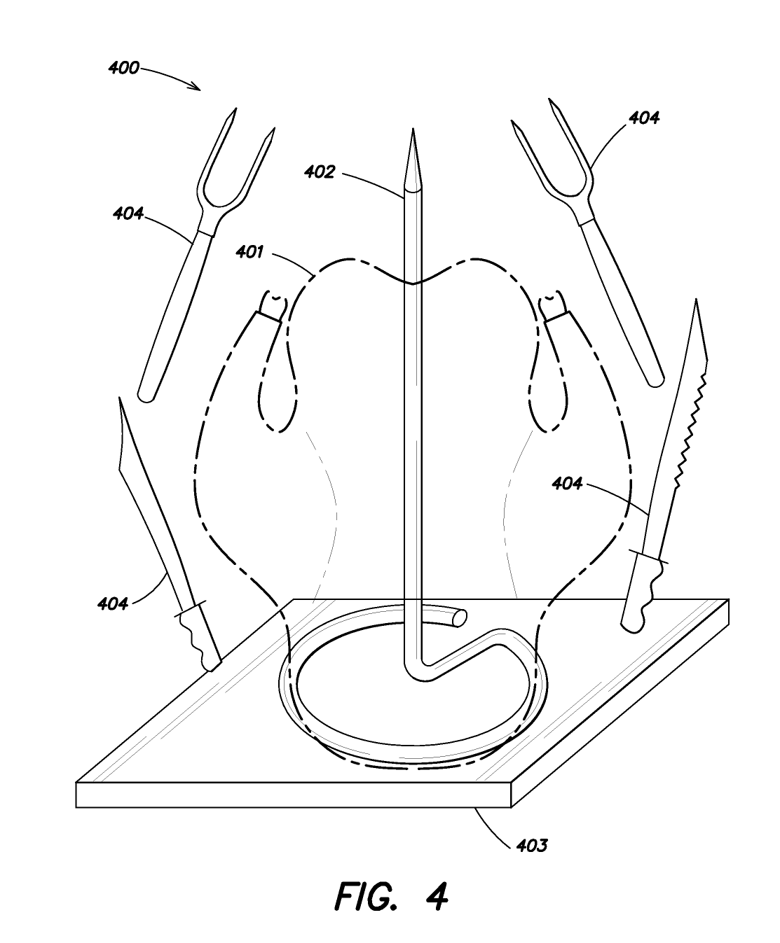

FIG. 4 shows an exemplary embodiment of a system for carving a cooked roast of this invention. The system 400 comprises a cooked roast 401, a carving pin of this invention 402, as detailed above, a carving board 403, and one or more carving instruments 404. The cooked roast 401 can be any cooked roast. The carving board 403 is a conventional carving board and can be made of any material and be of any size, as long as the cooked roast on the carving pin can rest on it. The carving instruments are those known in the art and include, for example, forks, knives, and prongs.

Other dimensions than those cited above are also contemplated; and the dimensions can vary slightly (i.e., be “about” a particular measurement), within art-accepted norms and art-accepted variations, and can be approximations.

All patents, patent publications, and references mentioned herein are incorporated by reference.

The foregoing description discloses only exemplary embodiments of the invention. Modifications of the above-disclosed carving pin, systems, methods, and kits which fall within the scope of the invention will be readily apparent to those of ordinary skill in the art.

The invention claimed is:

1. A carving pin for carving a cooked roast, comprising: a base and a spike member connected to the base at about a 90° angle, protruding upwards from the base, the spike member being at about the center of the base, the spike member comprising a spike member end and a spike member body, the spike member end being tapered and being located distally from the base, the spike member end and the spike member body being all in one piece, the spike member and the base being all in one piece, the spike member end being adapted to piece the cooked roast such that the cooked roast traverses the spike member and the cooked roast rests securely on the base.

2. The carving pin of claim 1, wherein the base is a square plate that is about 4 inches in length on each side.

3. The carving pin of claim 1, wherein the carving pin is made of stainless steel.

4. The carving pin of claim 1, wherein the spike member is about 7½ inches tall.

5. The carving pin of claim 1, wherein the spike member end is about ¾ inch long.

6. The carving pin of claim 1, wherein the spike member body is cylindrical.

7. The carving pin of claim 6, wherein the cylindrical spike member body is about 5/16 inch in diameter.

8. The carving pin of claim 1, wherein the base is either a square plate or a rectangular plate.

9. The carving pin of claim 1, wherein the base is a loop and one end of the loop abuts the spike member body.

10. The carving pin of claim 8, wherein the base is a square plate that is about 4 inches long on each side and is about ¼ inch thick, wherein the carving pin is made of stainless steel, wherein the spike member end is about ¾ inch long, wherein the spike member body is cylindrical and is about 5/16 inch in diameter, and wherein the spike member is about 7½ inches long.

11. The carving pin of claim 9, wherein the base is about 4 inches long, wherein the carving pin is made of stainless steel, wherein the spike member end is about ¾ inches long, wherein the spike member body is cylindrical and is about 5/16 inch in diameter, wherein the loop is cylindrical and is about 5/16 inch in diameter, and wherein the spike member is about 7½ inches long.

12. A method for carving a cooked roast, comprising:
(a) providing a carving pin, comprising: a base and a spike member connected to the base at about a 90° angle at about the center of the base, the spike member protruding upwards from the base, the spike member comprising a spike member end and a spike member body, the spike member end being tapered and being located distally from the base, the spike member end and the spike member body being all in one piece, the spike member and the base being all in one piece,
(b) providing a cooked roast,
(c) piercing the cooked roast with the spike member end such that the cooked roast traverses the spike member and the cooked roast is resting securely on the base,
(d) placing the cooked roast on the carving pin onto a carving board, and
(e) carving the cooked roast on the carving pin with one or more carving instruments, wherein both hands are free to hold the carving instruments.

13. The method according to claim 12, wherein the base is either a square plate or a rectangular plate.

14. The method according to claim 12, wherein the base is a loop with two ends and one end of the loop abuts the spike member body.

15. The method according to claim 13, wherein the base is a square plate that is about 4 inches long on each side and is about ¼ inch thick, wherein the carving pin is made of stainless steel, wherein the spike member end is about ¾ inch long, wherein the spike member body is cylindrical and is about 5/16 inch in diameter, and wherein the spike member is about 7½ inches long.

16. The method according to claim 14, wherein the base is about 4 inches long, wherein the carving pin is made of stainless steel, wherein the spike member end is about ¾ inch long, wherein the spike member body is cylindrical and is about 5/16 inch in diameter, wherein the loop is cylindrical and is about 5/16 inch in diameter, and wherein the spike member is about 7½ inches long.

17. A system for carving a cooked roast, comprising:
a cooked roast,
a carving pin comprising a base and a spike member connected to the base at about a 90° angle at about the center of the base, the spike member protruding upwards from the base, the spike member comprising a spike member end and a spike member body, the spike member end being tapered and being located distally from the base, the spike member end and the spike member body being all in one piece, the spike member and the base being all in one piece, the spike member end being adapted to pierce the cooked roast such that the cooked roast traverses the spike member and rests securely on the base,
a carving board on which the cooked roast and the carving pin are placed, the roast having traversed the spike member and resting securing on the base, and one or more carving instruments.

18. The system according to claim 17, wherein the base is either a square plate or a rectangular plate.

19. The system according to claim 18, wherein the base is a square plate that is about 4 inches long on each side and is about ¼ inch thick, wherein the carving pin is made of stainless steel, wherein the spike member end is about ¾ inch long, wherein the spike member body is cylindrical and is about 5/16 inch in diameter, and wherein the spike member is about 7½ inches long.

20. The system according to claim 17, wherein the base is a cylindrical loop with two ends, with one end abutting the spike member body, the loop being about 4 inches long, wherein the carving pin is made of stainless steel, wherein the spike member end is about ¾ inch long, wherein the spike member body is cylindrical and is about 5/16 inch in diameter, and wherein the spike member is about 7½ inches long.
